(19) United States
(12) Patent Application Publication
(10) Pub. No.: US 2008/0021635 A1
(43) Pub. Date: Jan. 24, 2008

(54) Method for establishing optimized paths of movement of vehicles

(75) Inventors: Winfried Lohmiller, Muenchen (DE); Sven Loechelt, Aachen (DE); Monica Barriuso Batet, Muenchen (DE); Ulrich Henning, Feldkirchen (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Muenchen (DE)

(21) Appl. No.: 11/826,793

(22) Filed: Jul. 18, 2007

(30) Foreign Application Priority Data
Jul. 19, 2006 (DE) 10 2006 033 347.0

(51) Int. Cl. G01C 21/00

(52) U.S. Cl. 701/202

(57) ABSTRACT

A method and apparatus for planning vehicle trajectories or routing in which a first optimized route between a starting point and a destination is established with regard to a first, relatively coarse node grid, using known techniques. In order to further refine route selection, a second relatively finer node grid is then established within a predeterminable area or volume that is adjacent yo the first optimized route, along its length. The latter finer node grid is then used to establish a second enhanced polygonal path from among the possible polygonal paths between the starting and destination points according to the finer node grid, once again using a known optimization technique.

### BACKGROUND AND SUMMARY OF THE INVENTION

This application claims the priority of German patent document 10 2006 033 347.0, filed Jul. 19, 2006, the disclosure of which is expressly incorporated by reference herein.

The invention relates to a method for planning and optimizing routing of a vehicle.

In the case of machines which are to be moved between different locations (here called starting point and destination), and for which there are many possible paths, the problem arises as to how the path which is optimum in terms of at least one optimization parameter (such as minimum traveling time or threat) can be established reliably and without an excessive expenditure. The problem as to which flight path is to be programmed in arises in particular in the case of low-level flying, because the straight flight path, with continuous ascent and descent of the flying object according to the height profile of the landscape along the selected path, is generally unfavorable with regard to flying time and fuel consumption.

The straight flight is also as a rule unfavorable from the point of view of safety (i.e., best possible coverage of the flying object during the flight), as this does not take coverage possibilities into account. Thus relatively large bodies of water as well as mountain peaks should be avoided as far as possible on account of low coverage. The preprogrammed flight path may have to be changed during the flight because of the sudden appearance of an obstacle or a dangerous area. It would then be highly desirable to optimize the path of movement again during the flight with regard to these new circumstances. It is not only in the case of unmanned flying objects, robot vehicles or the like that the problem of optimizing the path of movement may arise; it would also be conceivable in the case of manned machines, such as aircraft, for example, to establish an optimum flight path for automatic control of the aircraft (autopilot).

German patent document DE 39 27 299 C2 discloses a method for planning paths of movement in which a region lying between a starting point and a destination is discretized by establishing a number of nodes. From among the possible polygonal paths between the starting point and destination and extending via the nodes, the polygonal path which is optimum with regard to an optimization parameter is established in a known method.

The accuracy with which the optimum polygonal path can be determined depends on the resolution of the node grid. However the time required for calculating the optimum polygonal path increases significantly with the resolution of the node grid, as the entire node grid which can be obtained must be checked. Moreover, the path of movement of a flying object must be planned in real time during the flight. This real-time requirement limits the possible resolution of the node grid. In complex situations the resolution which is compatible with the real-time requirement may even no longer satisfy the flying requirements of the area.

German patent document DE 39 27 299 C2 discloses a method that solves this problem by applying a continuous optimization calculation (e.g., the known Ritz method) to the polygonal path established on the node grid. A disadvantage in this respect, however, is that inaccuracies in planning the path of movement due to an excessively coarse node grid can no longer be compensated through the continuous optimization calculation. Moreover, the complex equations of movement are difficult to model, and there is a risk of converging into a secondary minimum.

One object of the invention is to provide a method that determines a path of movement which is more accurate and robust than with the prior art.

This and other objects and advantages are achieved by the method and apparatus according to the invention, in which a first optimized route between a starting point and a destination is established with regard to a first, relatively course node grid, using known techniques. In order to further refine the route selection, a second relatively finer node grid is then established within a predeterminable area or volume that is adjacent to the first optimized route, along its length. The latter finer node grid is then used to establish an enhanced second polygonal path from among the possible polygonal paths between the starting and destination points according to the finer node grid, once again using a known optimization technique.

The invention also extends to and includes a computer readable medium encoded with a computer program for determining an optimized traveling or flight path for a vehicle by performing the method according to the invention, as well as to a system for determining such an optimized routing, including computer that is programmed to perform such steps.

Other objects, advantages and novel features of the present invention will become apparent from the following detailed description of the invention when considered in conjunction with the accompanying drawings.

### BRIEF DESCRIPTION OF THE DRAWINGS

FIG. 1 is a flow diagram which illustrates the steps of the process according to the invention;

FIG. 2 is a schematic depiction of a lattice comprising grid points utilized in performing the method according to the invention; and

FIG. 3 is a schematic block diagram of a system for selecting an optimized routing according to the invention.

### DETAILED DESCRIPTION OF THE DRAWINGS

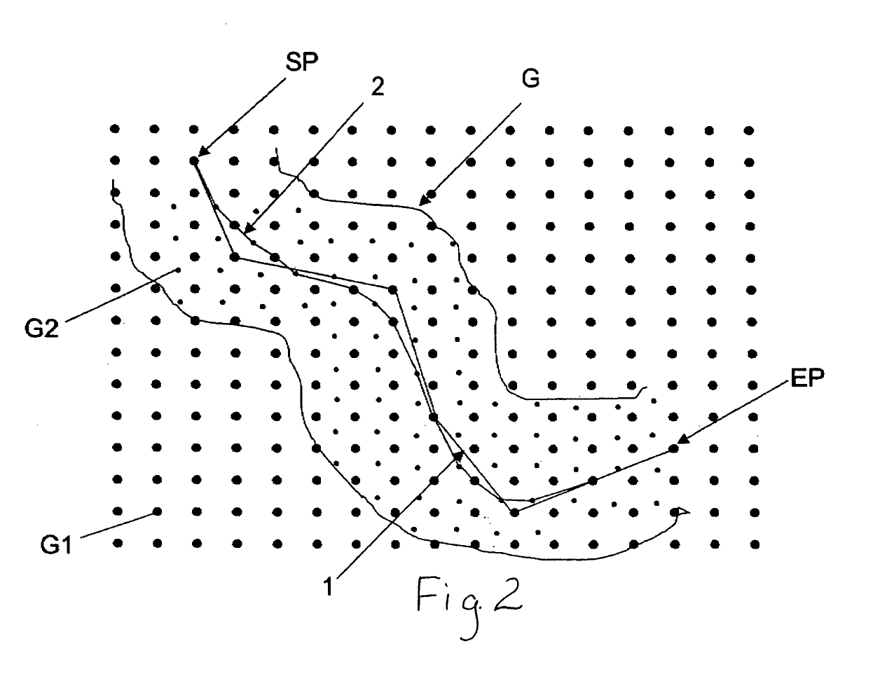

The starting point is a first polygonal path that is established (step 101) with regard to a predetermined optimization parameter from among the possible polygonal paths between the starting point and destination and extending over the first node grid (FIG. 2, discussed below). According to an embodiment of the invention, in steps 102 and 103 a predeterminable region is discretized (that is, a second finer grid pattern is defined within it), around the polygonal path established in the preceding step 101. This path (which may also be called the optimum path) may, for example, already be a smoothed flight curve. (The term “path” can therefore be understood to mean a “polygonal path” or a “flight path”.) The establishment of the finer second node grid (step 103) may, for example, be based on the first node grid; that is, all the grid points in the first node grid are also grid points in the second node grid. (See FIG. 2.) In this respect, in order to establish the region in which, with regard to the grid points of the first polynomial path, all the nth-degree grid points adjacent thereto can be used, wherein n is a positive integer.

The (finer) second node grid (FIG. 2) can of course also be selected without taking account of the first node grid. In this respect, in order to establish the region in which the finer second node grid is to be defined, a region which is obtained from a predeterminable perpendicular distance from a point on the first polynomial path is used, for example. For the three-dimensional case in the simplest form, the region for which a finer second node grid is to be defined lies within a tube with a predeterminable radius, wherein the first polygonal path defines the center axis of the tube.

The ratio of the size of a cell formed by direct neighbors (1st degree neighbors) of a grid point in the first node grid to the size of a cell formed from direct neighbors (1st degree neighbors) of a grid point in the second node grid should be at least 2. The size of a cell, depending on the dimension of the basic space, is understood to be the volume or the area of the cell. The basic space can in this respect have a dimension of greater than 2.

On this second node grid, which is finer than the first node grid, in step 104, a further polygonal path is established from among the possible polygonal paths between the starting point and destination and extending over the second node grid, with regard to the optimization parameter predetermined in step 101, which can expediently be modified. The polygonal path established in step 101 is not necessarily taken into account in the case of the further polygonal path established in step 104. That is, aside from being used to determine the area in which the second grid node is formed, the polygonal path established in step 101 has no further influence in establishing the further polygonal path in step 104, other than possibly being one of many paths from which the further polygonal path is determined.

In a further step 105, the optimum polygonal path established in step 104 is advantageously improved in a continuous optimization calculation or filtering/smoothing, while taking account of flyable conditions, in particular maximum acceleration or minimum flight curve radius. The filtering/smoothing can take place, for example, through a causal or noncausal nth-order low-pass filter. In this respect n corresponds, for example, to 2 when accelerations are to be filtered or 3 when the derivative of the acceleration (e.g., vehicle position) is to be filtered.

The optimum polygonal paths established in step 101 and/or step 104 can be established in a first implementation from polygonal paths which extend from the starting point to the destination and have been calculated according to Dijkstra's algorithm, Dijkstra's dual algorithm, or Dynamic Programming. Dijkstra's algorithm and Dijkstra's dual algorithm are known and are described in detail in European patent document EP 1 335 315 A2.

FIG. 2 illustrates an example of the invention, using a map model which is constructed of points of a first, coarse lattice which comprises grid points G1 at a given spacing (here constant). On this lattice the start and end points of the trajectory SP and EP are indicated. In a first phase a coarsely optimized polygonal path 1 is calculated along the grid points of the first lattice G1.

A region G around this path is then calculated according to preset criteria. For instance, it can be simply all points within a certain perpendicular distance of the coarse path 1. Within this area G, and only within it, a finer lattice which comprises grid points G2 is set up, which in the present case includes all the existing grid points of G1 and further, intermediate points indicated by smaller dots. The optimized path is then recalculated using G2, within this restricted region, giving the final path 2.

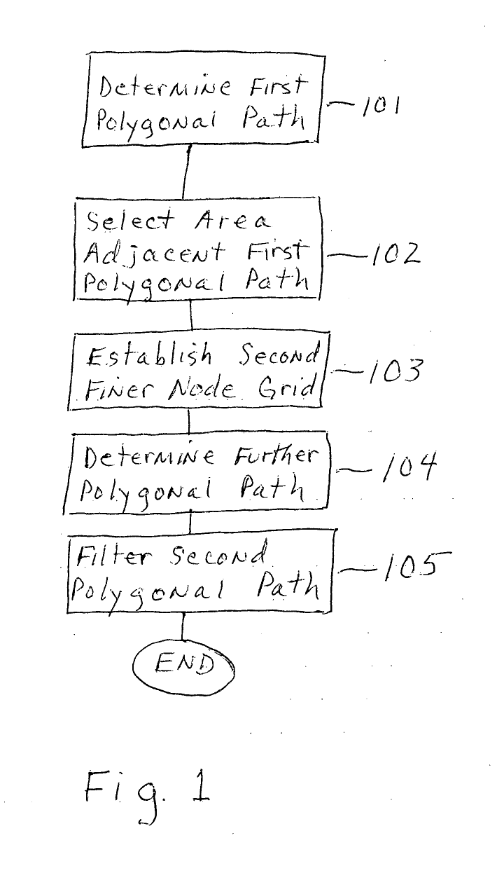

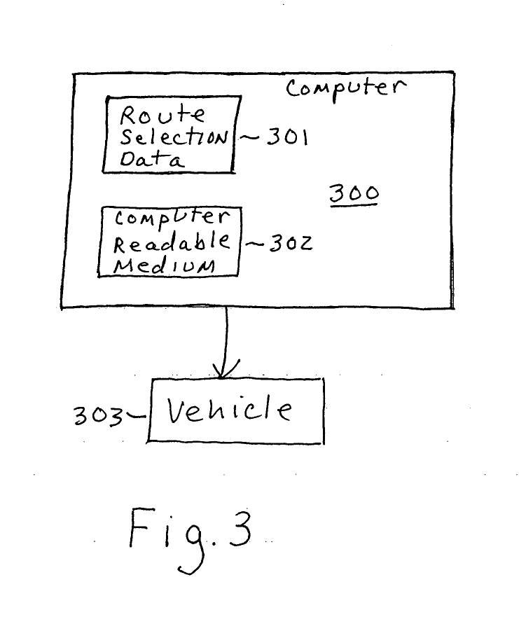

FIG. 3 illustrates an embodiment of a system for optimizing vehicle routing according to the invention, which includes a computer or data processor 300, which has stored therein a terrain model or other data 301 which characterize considerations that are relevant to the route selection process, such as flyable conditions, maximum acceleration, minimum flight curve radius, fuel consumption, speed factors and minimum danger data and derivatives thereof. In addition, the computer also contains a computer readable medium 302 which is encoded with a computer program for causing the computer to perform the steps illustrated in FIG. 1 for selecting an optimum vehicle routing. As depicted in FIG. 3, an output from the computer is provided to the vehicle 303 or to an operator of the vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. A method for planning an optimized routing for a vehicle, said method comprising:
discretizing a region between a starting point and a destination by establishing a first node grid;
establishing a first polygonal path which is optimal with regard to at least one predetermined optimization parameter, from among possible polygonal paths between the starting point and destination and extending over the first node grid; and
determining a predeterminable region around the first polygonal path;
establishing within said predeterminable region a more finely divided second node grid; and
from among possible paths between the starting point and destination, establishing a second polygonal path which is optimized with respect to the predetermined optimization parameter based on nodes contained in the second node grid.

2. The method according to claim 1, wherein the second polygonal path is improved in a continuous optimization calculation or filtering/smoothing, taking account of flyable conditions, including at least one of maximum acceleration, minimum flight curve radius or the derivative.

3. The method according to claim 1, wherein a ratio of size of a cell formed by direct neighbors of a grid point in the first node grid to a size of a cell formed by direct neighbors of a grid point in the second node grid is at least 2.

4. The method according to claim 1, wherein the respective optimum paths are established from paths which extend from the starting point to the destination and have been calculated according to Dijkstra's algorithm.

5. The method according to claim 1, wherein the respective optimum paths are established from paths which extend from the starting point to the destination and have been calculated according to Dijkstra's dual algorithm.

6. The method according to claim 1, wherein a plurality of weightable optimization parameters are taken into account.

7. The method according to claim 6, wherein said weightable optimization parameters comprise at least one of minimum danger, speed or minimum danger and fuel consumption.

8. A computer readable medium encoded with a computer program that includes instructions which, when loaded into a computer, cause the computer to perform an optimized route selection for a vehicle, according to the following steps:
discretizing a region between a starting point and a destination by establishing a first node grid;
establishing a first polygonal path which is optimal with regard to at least one predetermined optimization parameter, from among possible polygonal paths between the starting point and destination and extending over the first node grid; and
determining a predeterminable region around the first polygonal path;
establishing within said predeterminable region a more finely divided second node grid; and
from among possible paths between the starting point and destination, establishing a second polygonal path which is optimized with respect to the predetermined optimization parameter based on nodes contained in the second node grid.

9. The method according to claim 8, wherein the second polygonal path is improved in a continuous optimization calculation or filtering/smoothing, taking account of flyable conditions, including at least one of maximum acceleration, minimum flight curve radius or the derivative.

10. The method according to claim 8, wherein a ratio of size of a cell formed by direct neighbors of a grid point in the first node grid to a size of a cell formed by direct neighbors of a grid point in the second node grid is at least 2.

11. The method according to claim 8, wherein a plurality of weightable optimization parameters are taken into account.

12. The method according to claim 11, wherein said weightable optimization parameters comprise at least one of minimum danger, speed or minimum danger and fuel consumption.

13. A system for planning an optimized routing for a vehicle, said system comprising:
a computer;
a memory contained in said computer and having stored therein data which are indicative of parameters that influence desirability of possible alternative routes; and
a computer readable medium which is accessible by said computer, and which has encoded therein a computer program which, when loaded into said computer, causes it to perform an optimized route selection for a vehicle, including
discretizing a region between a starting point and a destination by establishing a first node grid;
establishing a first polygonal path which is optimal with regard to at least one predetermined optimization parameter, from among possible polygonal paths between the starting point and destination and extending over the first node grid; and
determining a predeterminable region around the first polygonal path;
establishing within said predeterminable region a more finely divided second node grid; and
from among possible paths between the starting point and destination, establishing a second polygonal path which is optimized with respect to the predetermined optimization parameter based on nodes contained in the second node grid.

14. The method according to claim 13, wherein the second polygonal path is improved in a continuous optimization calculation or filtering/smoothing, taking account of flyable conditions, including at least one of maximum acceleration, minimum flight curve radius or the derivative.

15. The method according to claim 13, wherein a ratio of size of a cell formed by direct neighbors of a grid point in the first node grid to a size of a cell formed by direct neighbors of a grid point in the second node grid is at least 2.

16. The method according to claim 13, wherein a plurality of weightable optimization.

17. The method according to claim 12, wherein said weightable optimization parameters comprise at least one of minimum danger, speed or minimum danger and fuel consumption.
